(19) United States
(12) Patent Application Publication
(10) Pub. No.: US 2026/0201731 A1
(43) Pub. Date: Jul. 16, 2026

(54) LOCK ASSEMBLY FOR TOWING-TYPE HOUSE

(71) Applicant: Jialong WEI, Nanyang (CN)

(72) Inventor: Jialong WEI, Nanyang (CN)

(21) Appl. No.: 19/021,680

(22) Filed: Jan. 15, 2025

(51) Int. Cl. E05B 47/00

(52) U.S. Cl. CPC E05B 47/0001; E05B 83/44; E05B 2047/0017; E05B 2047/002; E05B 2047/0067; E05B 2047/0088

(57) ABSTRACT

The present invention belongs to the technical field of electronic door locks and relates to a lock assembly for a towing-type house. The lock assembly includes: a housing; a key lock, which is mounted on an external portion of the housing and has a locking position and an unlocking position; a deadbolt guide shaft, which is mounted in the housing rotatably, connected to the key lock to rotate with the key lock, and provided with a driven bevel gear; a poking rod, which is operably connected to the deadbolt guide shaft; a deadbolt, which is movably mounted in the housing, may move between the locking position and the unlocking position, and is operably connected to the poking rod; and a motor.

### TECHNICAL FIELD

The present invention belongs to the technical field of electronic door locks and relates to lock assembly for a towing-type house.

### BACKGROUND

A towing-type house is widely used in outdoor camping and mobile living due to its flexibility and portability. However, an existing door lock system of the towing-type house generally has problems such as complex structures, low driving efficiency, and insufficient safety. Generally, in the prior art, a clutch or connecting rod driving method is adopted, which has a long power transmission path and large losses, resulting in low driving efficiency. In addition, during the traveling of the towing-type house, due to the severe vibration of a vehicle, internal parts and components of the door lock are prone to dislocation or abrasion, which may cause that a motor cannot drive a latch bolt to operate normally in severe cases and even that a key cannot be used for unlocking.

In another aspect, most of the door locks of the towing-type house currently on the market lack a real-time positioning function on a state of the latch bolt, and a user cannot clearly judge opening and closing states of the latch bolt. In a complex road condition, vibration may also cause the latch bolt to open accidentally, thereby leading to safety hazards such as damage to the door lock or loss of objects in the house. These problems not only increase use difficulty and maintenance costs of the user, but also have a negative impact on the reliability and service life of the product.

### SUMMARY

A purpose of the present invention is to provide a lock assembly for a towing-type house in view of deficiencies in the prior art, to enhance stability and provide feedback on a positioning function.

To achieve the foregoing purpose, the present invention adopts the following technical solutions:

A lock assembly for a towing-type house includes:
a housing;
a key lock, which is mounted on an external portion of the housing and has a locking position and an unlocking position;
a deadbolt guide shaft, which is mounted in the housing rotatably, connected to the key lock to rotate with the key lock, and provided with a driven bevel gear;
a poking rod, which is operably connected to the deadbolt guide shaft;
a deadbolt, which is movably mounted in the housing, can move between the locking position and the unlocking position, and is operably connected to the poking rod; and
a motor, which has a locking position and an unlocking position and is engaged with the driven bevel gear through a driving bevel gear on a rotating shaft of the motor to drive the deadbolt guide shaft to rotate.

Further, the motor is mounted vertically and located above the deadbolt guide shaft.

Further, one end of the poking rod is connected to the deadbolt guide shaft, and the other end thereof is provided with a boss;
the deadbolt is provided with a guide groove, and the boss is located in the guide groove; and
when the motor or the key lock switches between the locking position and the unlocking position, the deadbolt guide shaft rotates simultaneously and is matched with the guide groove through the boss on the poking rod to drive the deadbolt to switch between the locking position and the unlocking position.

Further, when the poking rod drives the deadbolt to directly switch between the locking position and the unlocking position, a position of the poking rod is on two sides of a perpendicular bisector of the deadbolt guide shaft respectively.

Further, the lock assembly for a towing-type house further includes:
an external handle, which is rotatably mounted on the external portion of the housing and can rotate between a retracting position and an extending position; and
a latch bolt, which is connected to the external handle operably and configured as follows: when the external handle is at the retracting position, the latch bolt is at a locking closing position, and a closure apparatus cannot accidentally move from a closing position at this time; and when the external handle is at the extending position, the latch bolt is at an unlocking position, and the closure apparatus can move from the closing position to an opening position at this time.

Further, the lock assembly for a towing-type house further includes an electronic control panel, which is mounted on the external portion of the housing and operably connected to the motor, where a preset digital code is input to drive the motor and simultaneously switch the locking position and the unlocking position of the deadbolt.

Further, the lock assembly for a towing-type house further includes a first sensor and a second sensor, which are mounted in the housing;
the deadbolt is provided with a triggering portion; and
when the deadbolt switches between the locking position and the unlocking position, the triggering portion triggers the first sensor and the second sensor respectively.

Further, the first sensor and the second sensor are magnetic sensors, and the triggering portion is a magnet.

Further, the first sensor and the second sensor are micro motion sensors, and the triggering portion is a convex block.

Further, the lock assembly for a towing-type house further includes a wireless transmission unit, which is configured to transmit triggering states of the first sensor and the second sensor to an external device.

According to the technical solutions of the present invention, an engagement structure of the driving bevel gear and the driven bevel gear is adopted, to implement efficient power transmission of the motor and accurate power conversion, and a stable operation may be maintained under a complex road condition. The poking rod is connected to the deadbolt through mechanical structures of the boss and the guide groove, to ensure that an operation path of the deadbolt is accurate and controlled, thereby improving reliability of the deadbolt switching between the locking position and the unlocking position and preventing the deadbolt from staggering or seizure in a severe vibration environment of the towing-type house. The first sensor and the second sensor are equipped to detect the locking position and the unlocking position of the deadbolt respectively. In a complex environment, it is ensured that an opening and closing states of the latch bolt are clearly visible, thereby improving use experience.

Additional features and advantages of the present invention will be set forth in the description which follows, and in part will be obvious from the description, or may be learned by implementing the present invention. The purposes and other advantages of the present invention may be realized and obtained by a structure particularly pointed out in the written specification and drawings.

### BRIEF DESCRIPTION OF THE DRAWINGS

The present invention is described in detail below with reference to the drawings, so as to make the above advantages of the present invention clearer.

FIG. 1 is a schematic diagram of a lock assembly for a towing-type house according to the present invention;

FIG. 2 is a schematic internal diagram of a lock assembly for a towing-type house according to the present invention;

FIG. 3 is a schematic assembling diagram of a deadbolt guide shaft 300 of a lock assembly for a towing-type house according to the present invention;

FIG. 4 is a schematic assembling diagram of a deadbolt of a lock assembly for a towing-type house according to the present invention;

FIG. 5 is a schematic diagram of a deadbolt guide shaft of a lock assembly for a towing-type house according to the present invention;

FIG. 6 is a schematic diagram of a deadbolt at a locking position of a lock assembly for a towing-type house according to the present invention;

FIG. 7 is a schematic diagram of a deadbolt at an unlocking position of a lock assembly for a towing-type house according to the present invention;

FIG. 8 is a schematic diagram of positions of a first sensor and a second sensor of a lock assembly for a towing-type house according to the present invention; and

FIG. 9 is a connection block diagram of a wireless transmission unit of a lock assembly for a towing-type house according to the present invention.

### DETAILED DESCRIPTION OF THE EMBODIMENTS

Embodiments of the present invention are described in detail below and examples of the embodiments are shown in the accompanying drawings, where the same or similar reference numerals always represent the same or similar elements or elements with the same or similar functions. The embodiments described below with reference to the accompanying drawings are exemplary and are intended to explain the present invention, but shall not be understood as a limitation on the present invention.

In the description of the present invention, it should be noted that, the orientations or positional relationships indicated by the terms “length”, “width”, “up”, “down”, “front”, “back”, “left”, “right”, “vertical”, “horizontal”, “top”, “bottom”, “inside”, “outside”, and the like are based on those shown in the accompanying drawings, intended only for the convenience of describing the present invention and for simplifying the description, and not intended to indicate or imply that the referred apparatus or element must be provided with a particular orientation or constructed and operated with a particular orientation, therefore not allowed to be construed as a limitation of the present invention.

Furthermore, the terms “first” and “second” are intended only for descriptive purposes and should not be construed as indicating or implying their relative importance or implying the quantity of technical features indicated. Therefore, a feature limited by “first” or “second” may explicitly or implicitly include one or more features. In the description of the present invention, the meaning of “plurality” is at least two, unless otherwise specifically defined.

In the embodiments of the present invention, unless otherwise expressly specified and defined, the terms “mounted”, “attached”, “connected”, “fixed”, and the like should be understood in a broad sense, for example, a connection may be a fixed connection, a detachable connection, or an integral connection; it may be a mechanical connection or an electrical connection; it may be a direct connection or an indirect connection via an intermediate medium; and it may be a connection between two elements or an interaction between two elements. For those of ordinary skill in the art, the specific meanings of the above terms in the present invention can be understood on a case-by-case basis.

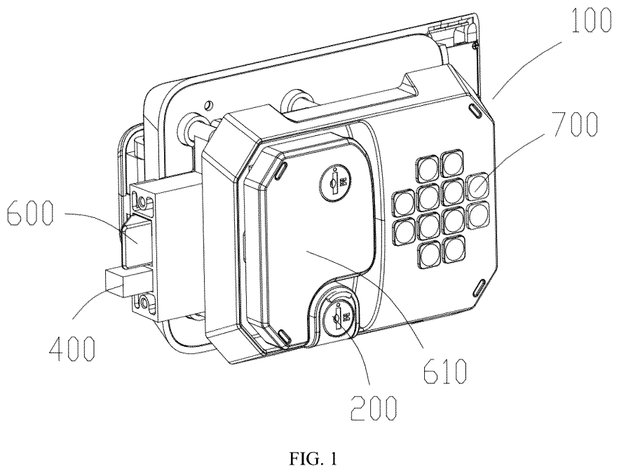

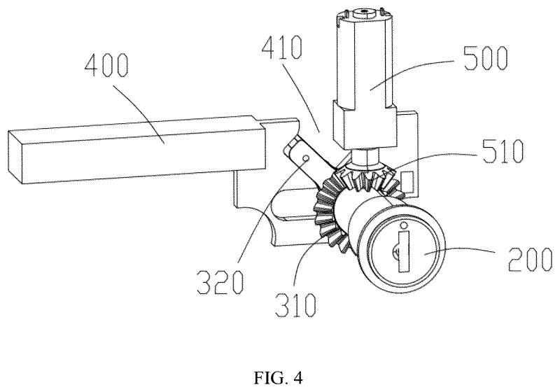

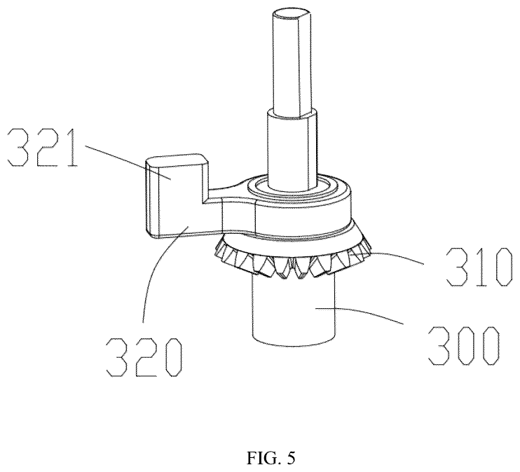

Referring to FIG. 1 to FIG. 9, a lock assembly for a towing-type house includes:
a housing 100;
a key lock 200, which is mounted on an external portion of the housing 100 and has a locking position and an unlocking position;
a deadbolt guide shaft 300, which is mounted in the housing 100 rotatably, connected to the key lock 200 to rotate with the key lock, and provided with a driven bevel gear 310;
a poking rod 320, which is operably connected to the deadbolt guide shaft 300;
a deadbolt 400, which is movably mounted in the housing 100, may move between the locking position and the unlocking position, and is operably connected to the poking rod 320; and
a motor 500, which has a locking position and an unlocking position and is engaged with the driven bevel gear 310 through a driving bevel gear 510 on a rotating shaft of the motor to drive the deadbolt guide shaft 300 to rotate.

By adopting a driving manner that the driving bevel gear 510 is matched with the driven bevel gear 310, the motor 500 drives the deadbolt guide shaft 300 through the driving bevel gear 510 to rotate, thereby implementing high efficiency and stability of driving. Through the design of a bevel gear, rotary power output by the motor 500 can be accurately transmitted to the deadbolt guide shaft 300, and movement of the deadbolt 400 can be controlled through the poking rod 320. The deadbolt guide shaft 300 is connected to the key lock 200, so that a user may manually switch a locking state and an unlocking state of the deadbolt 400 through a key. The motor 500 switches the deadbolt 400 in an automatic control manner, which does not interfere with manual control, thereby enhancing redundancy and reliability of a system.

The motor 500 is engaged with the driven bevel gear 310 on the deadbolt guide shaft 300 through the driving bevel gear 510 on the rotating shaft of the motor. When the motor 500 is started, the driving bevel gear 510 drives the driven bevel gear 310 to rotate, thereby driving the deadbolt guide shaft 300 to rotate. The deadbolt guide shaft 300 drives the deadbolt 400 to move between the locking position and the unlocking position through matching with the poking rod 320 when rotating.

The user switches the locking position and the unlocking position through the key lock 200, and the key lock 200 directly drives the deadbolt guide shaft 300 to rotate. Similarly, the deadbolt guide shaft 300 drives the deadbolt 400 to switch a state through matching with the poking rod 320 when rotating.

The motor 500 and the key lock 200 do not interfere with each other, thereby ensuring that the door lock may still be manually operated when the motor 500 is invalid or is powered off.

Bevel gear driving has a characteristic of efficient energy transmission, so that energy losses in a traditional link mechanism are reduced, an operation is stable, and noise is low. An engagement manner of the bevel gear can adapt to a bumpy environment of the towing-type house, thereby ensuring stability during driving.

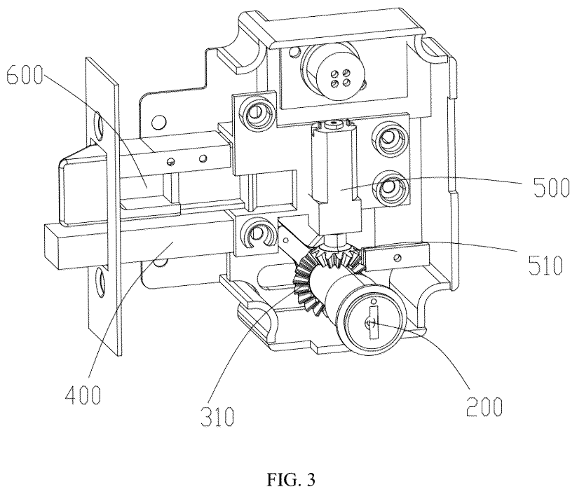

Referring to FIG. 3, in the embodiment, the motor 500 is mounted vertically and located above the deadbolt guide shaft 300. The design of vertical mounting of the motor 500 fully uses vertical space in the housing 100 of the lock assembly, thereby effectively reducing transverse occupation. The deadbolt guide shaft 300 is vertical to the motor 500 in space, so that an overall layout is more compact. The motor 500 mounted vertically can directly transmit power to the deadbolt guide shaft 300, thereby reducing redundant rotating components and improving driving efficiency.

The motor 500 is mounted vertically to effectively avoid a problem of an eccentric force or vibration that may be caused by transverse mounting. With a firm mounting foundation, rotary torque of the motor 500 can be stably transmitted to the deadbolt guide shaft 300. During traveling of the towing-type house, the motor 500 mounted vertically has a centralized center of gravity, which helps reduce a problem of loose mounting or unstable driving caused by the vibration.

Referring to FIG. 3 to FIG. 5, in the embodiment, one end of the poking rod 320 is connected to the deadbolt guide shaft 300, and the other end thereof is provided with a boss 321.

The deadbolt 400 is provided with a guide groove 410, and the boss 321 is located in the guide groove 410.

When the motor 500 or the key lock 200 switches between the locking position and the unlocking position, the deadbolt guide shaft 300 rotates simultaneously and is matched with the guide groove 410 through the boss 321 on the poking rod 320 to drive the deadbolt 400 to switch between the locking position and the unlocking position.

Through a mechanical connection between the poking rod 320 and the deadbolt 400, and by using movement space of the boss 321 in the guide groove 410, the boss 321 is dynamically matched with the guide groove 410, and rotary movement of the deadbolt guide shaft 300 is effectively converted into linear sliding of the deadbolt 400. The design ensures that the deadbolt 400 can stably slide between the locking position and the unlocking position, thereby providing a reliable foundation for an efficient operation of the lock assembly.

The deadbolt 400 is slidably mounted in the housing 100 and is provided with the guide groove 410. The guide groove 410 provides the movement space for the boss 321, so that the boss 321 may move in the guide groove. The movement of the boss 321 in the guide groove 410 drives the deadbolt 400 to linearly slide between the locking position and the unlocking position through force transmission.

When the deadbolt guide shaft 300 rotates, the boss 321 moves with the poking rod 320 and moves in the guide groove 410. The matching between the boss 321 and the guide groove 410 enables a rotary force of the boss 321 to be transmitted to the deadbolt 400 along a sliding direction of the guide groove 410, thereby driving the deadbolt 400 to slide. After the motor 500 is started, the driving bevel gear 510 drives the driven bevel gear 310 to rotate, so that the deadbolt guide shaft 300 synchronously rotates. Rotation of the deadbolt guide shaft 300 transmits power to the deadbolt 400 through the poking rod 320, and the linear sliding of the deadbolt 400 is completed through matching between the boss 321 and the guide groove 410.

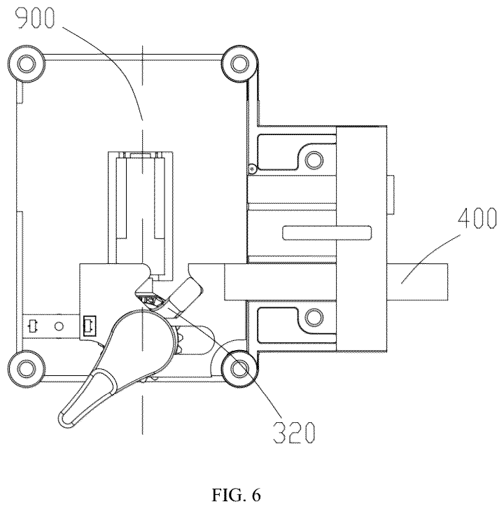

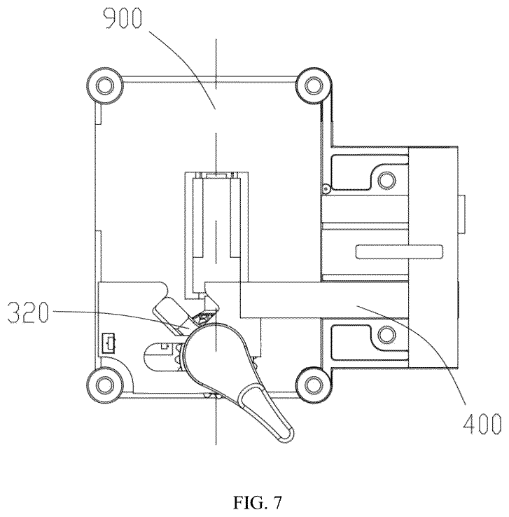

Referring to FIG. 6 and FIG. 7, in the embodiment, when the poking rod 320 drives the deadbolt 400 to directly switch between the locking position and the unlocking position, a position of the poking rod 320 is on two sides of a perpendicular bisector 900 of the deadbolt guide shaft 300 respectively.

During rotation of the deadbolt guide shaft 300, the poking rod 320 needs to be in two opposite directions of the deadbolt guide shaft 300 respectively when at the locking position or the unlocking position. Through this layout design, the poking rod 320 can effectively use constraints of gravity and a mechanical force, to provide stable support in the locking state or the unlocking state, which is particularly suitable for an operation environment of the towing-type house under a complex road condition, thereby avoiding a risk of accidental unlocking caused by an external force.

When the deadbolt 400 is at the locking position or the unlocking position, the poking rod 320 is in the two opposite directions relative to the deadbolt guide shaft 300. This layout ensures that the poking rod 320 always returns to a stable position after the deadbolt 400 completes switching and drives the deadbolt 400 to remain controlled in straight sliding through the matching between the boss 321 and the guide groove 410.

At the locking position, the poking rod 320 points to a direction due to the rotation of the deadbolt guide shaft 300. At the unlocking position, the poking rod 320 rotates to a position opposite to a locking direction. This design of opposite direction minimizes a risk of deviation or accidental sliding.

This design of opposite directions may effectively absorb vibration during traveling of the towing-type house, to prevent the deadbolt 400 from sliding to another position unanticipatedly.

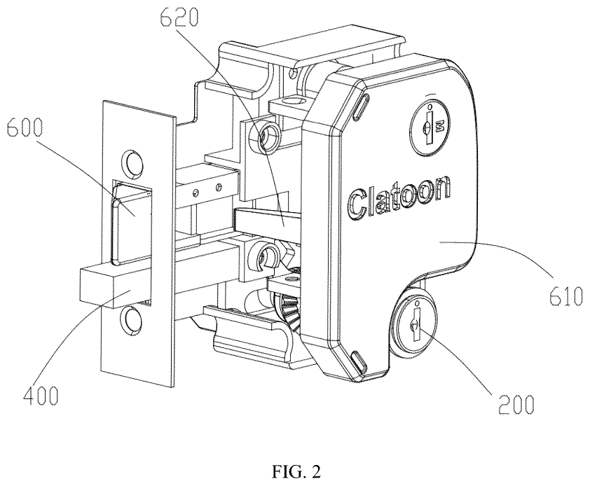

Referring to FIG. 1 and FIG. 2, in the embodiment, the lock assembly for a towing-type house further includes:
an external handle 610, which is rotatably mounted on the external portion of the housing 100 and can rotate between a retracting position and an extending position; and
a latch bolt 600, which is connected to the external handle 610 operably and configured as follows: when the external handle 610 is at the retracting position, the latch bolt 600 is at a locking closing position, and a closure apparatus cannot accidentally move from a closing position at this time; and when the external handle 610 is at the extending position, the latch bolt 600 is at an unlocking position, and the closure apparatus may move from the closing position to an opening position at this time. The external handle 610 drives the latch bolt 600 through a rotating rod 620.

The lock assembly implements both convenience and safety by introducing two independent and functionally-complementary systems: a latch bolt 600 system and a deadbolt 400 system. The latch bolt 600 system takes the external handle 610 as a core and mainly provides convenient opening and closing functions for the user. The deadbolt 400 system is used as an additional insurance measure, to enhance safety of the towing-type house under a special or a complex environment.

The user rotates the external handle 610 to easily control a state of the latch bolt 600. The latch bolt 600 is slidably mounted in the housing 100 and switches between the locking closing position and the unlocking position through a mechanical linkage with the external handle 610, which facilitates rapidly opening and closing the door lock by the user and is applicable for a daily use scenario.

In daily use, the user may implement rapid opening and closing by using the latch bolt 600 system only. When additional protection is needed, the deadbolt 400 system is activated to improve safety. The two sets of systems are independent and do not interfere with each other, to ensure balance between convenience and safety.

Referring to FIG. 1, in the embodiment, the lock assembly for a towing-type house further includes an electronic control panel 700, which is mounted on the external portion of the housing 100 and operably connected to the motor 500. A preset digital code is input to drive the motor 500 and simultaneously switch the locking position and the unlocking position of the deadbolt 400. The electronic control panel 700 is added, so that digitalized and intelligentized operation functions are implemented. The electronic control panel 700 is mounted on the external portion of the housing 100 and directly connected to the motor 500. The user inputs the preset digital code to control the motor 500 to operate, thereby driving the deadbolt 400 to switch between the locking position and the unlocking position. This design provides convenient and efficient operation manners and enhances safety and intelligentized levels of the door lock.

The user inputs the preset digital code through the electronic control panel 700, and a controller mounted in the control panel verifies the input code. If the input digital code is correct, the controller sends a starting instruction to the motor 500; and if the input digital code is false, the system keeps the deadbolt 400 in an original state, and unlocking cannot be implemented. After the controller sends a signal, the motor 500 is started and drives the driven bevel gear 310 through the driving bevel gear 510 to rotate. The deadbolt guide shaft 300 rotates correspondingly. The poking rod 320 converts the rotary movement into the linear sliding of the deadbolt 400 through the matching between the boss 321 and the guide groove 410 of the deadbolt 400, thereby completing a locking operation or an unlocking operation.

The user does not need to carry a physical key and only needs to input the digital code to complete the locking operation or the unlocking operation, thereby simplifying a use procedure.

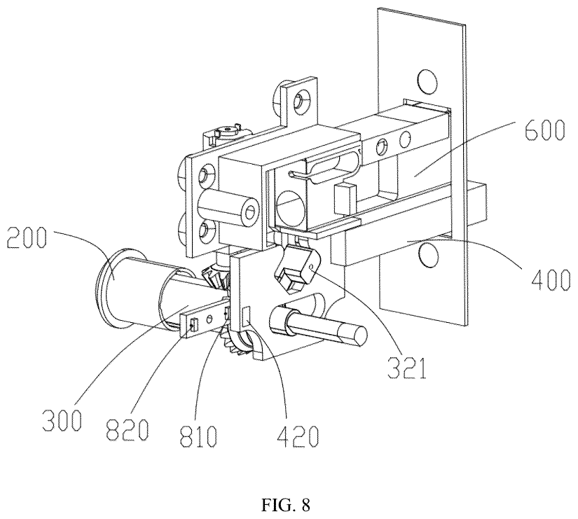

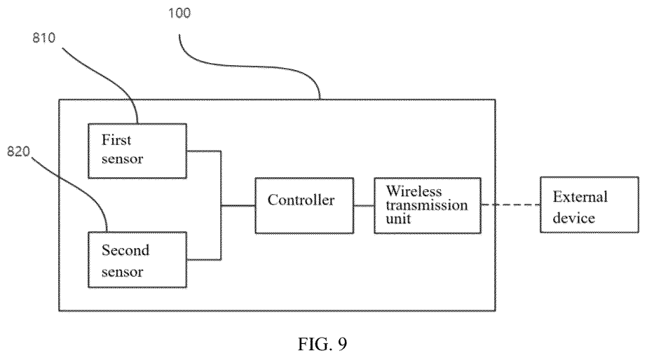

Referring to FIG. 8 and FIG. 9, in the embodiment, the lock assembly for a towing-type house further includes a first sensor 810 and a second sensor 820, which are mounted in the housing 100;
the deadbolt 400 is provided with a triggering portion 420; and
when the deadbolt 400 switches between the locking position and the unlocking position, the triggering portion 420 triggers the first sensor 810 and the second sensor 820 respectively. The first sensor 810 and the second sensor 820 are added in the housing 100, so that a position of the deadbolt 400 is monitored in real time. The triggering portion 420 disposed on the deadbolt 400 can interact with the two sensors respectively. When the deadbolt 400 switches between the locking position and the unlocking position, the triggering portion 420 triggers a corresponding sensor. This design enables the system to judge a current state of the deadbolt 400 accurately and provide real-time feedback for the user, thereby further improving intelligentization and safety of the lock assembly.

The first sensor 810 is mounted at a detection point where the deadbolt 400 is at the locking position. The second sensor 820 is mounted at a detection point where the deadbolt 400 is at the unlocking position. Layouts of the two sensors correspond to a sliding path of the deadbolt 400, to ensure that the deadbolt 400 can accurately trigger the two sensors when reaching a designated position.

The triggering portion 420 disposed on the deadbolt 400 is a component specially configured to interact with the sensor, which may be a magnetic trigger, a mechanical convex block, or another suitable form. When the deadbolt 400 moves to the designated position, the triggering portion 420 is in contact with or senses the corresponding sensor, thereby completing state switching detection.

The two sensors are connected to the controller of the electronic control panel 700 and transmit a detected signal to the controller through a circuit. The controller judges the state of the deadbolt 400 according to the signal of the sensors and provides the real-time feedback for the user.

When the deadbolt 400 is at the locking position, the triggering portion 420 is in contact with the first sensor 810, and the sensor sends a “locking” signal to the controller. When the deadbolt 400 moves to the unlocking position, the triggering portion 420 leaves the first sensor 810 and triggers the second sensor 820, and the sensor sends an “unlocking” signal to the controller. When the deadbolt 400 does not completely reach an anticipated position, the system may send an alarm or prompt the user to re-operate. In a bumpy or vibrating environment of the towing-type house, the sensors can provide additional state verification, to ensure accuracy of the position of the deadbolt 400. Real-time state feedback enables the user to intuitively learn about an operation condition of the deadbolt 400, thereby reducing a repeated operation caused by an uncertain state.

In the embodiment, the first sensor 810 and the second sensor 820 are magnetic sensors, and the triggering portion 420 is a magnet. The magnetic sensors are highly sensitive to a change in a magnetic field and can rapidly respond to a change in the position of the deadbolt 400, thereby providing accurate state detection. The magnetic sensors do not need to be in direct contact with the magnet, thereby avoiding a problem of decreased detection accuracy caused by vibration or abrasion, which are particularly suitable for the complex road condition of the towing-type house. The magnetic sensors and the magnet are made of a material with strong durability and can maintain stable performance for a long time in high-frequency use and a harsh environment.

A first magnetic sensor is mounted at the locking position of the deadbolt 400 and configured to detect whether the deadbolt 400 is in the locking state. A second magnetic sensor is mounted at the unlocking position of the deadbolt 400 and configured to detect whether the deadbolt 400 is in the unlocking state. The magnet is close to or leaves the magnetic sensors in sequence during sliding and triggers a magnetic field sensing signal. After sensing the change in the magnetic field, the magnetic sensors transmit the signal to the controller. The controller judges the state of the deadbolt 400 according to the signal and feeds the state back to the user through the electronic control panel 700 or another output device.

In another embodiment, the first sensor 810 and the second sensor 820 are micro motion sensors, and the triggering portion 420 is a convex block. The micro motion sensors are combined with the convex block triggering portion 420, so that mechanical accurate detection of the state of the deadbolt 400 is implemented. The micro motion sensors are mounted on fixed positions of the sliding path of the deadbolt 400, and a convex block on the deadbolt 400 is used as the triggering portion 420. When switching to the locking position or the unlocking position, the deadbolt 400 triggers a corresponding micro motion sensor. The design uses a mechanical contact detection manner and has characteristics of low costs, simple structures, and high reliability.

As a mechanical component on the deadbolt 400, the convex block slides synchronously with the deadbolt 400. When the deadbolt 400 slides to the designated position, the convex block presses contact points of the micro motion sensors, thereby completing state switching detection. After the contact points of the micro motion sensors are closed, the signal is transmitted to the controller through the circuit.

Manufacturing costs of the micro motion sensors are low, and the convex block triggering portion 420 does not need a special material or a complex processing technology. Therefore, an overall design is economical and practical. The convex block adopts a high-strength plastic or metal material and can withstand long-term mechanical pressure without deformation.

Referring to FIG. 9, in the embodiment, the lock assembly for a towing-type house further includes a wireless transmission unit, which is configured to transmit triggering states of the first sensor 810 and the second sensor 820 to an external device. A wireless communication module is, for example, a Wi-Fi, Bluetooth, or ZigBee module and an antenna and signal processing circuit. The wireless transmission unit is integrated in the housing 100, connected to the controller through an internal circuit, and configured to receive state signals of the sensors and perform remote transmission. The first sensor 810 and the second sensor 820 are connected to the controller through a signal line, and the triggering states of the sensors are transmitted to the wireless transmission unit after processed by the controller. The wireless transmission unit is wirelessly connected to an intelligent terminal such as a mobile phone or a tablet of the user, and the user views the state of the deadbolt 400 in real time through a mating application. The user may monitor an operation state of the lock assembly anytime and anywhere. This design improves an intelligentized level of the lock assembly and operation convenience of the user and is suitable for modern safety management requirements.

During traveling of the towing-type house, the user remotely monitors the state of the deadbolt 400, to ensure a normal operation of the lock assembly in a vibration environment.

Finally, it should be noted that: the foregoing descriptions are merely preferred embodiments of the present invention, but are not intended to limit the present invention. Although the present invention has been described in detail with reference to the foregoing embodiments, those skilled in the art will readily appreciate that they can make modifications to technical solutions recorded in the embodiments described herein, or make equivalent replacements of some of the features described herein. Any modifications, equivalent replacements, improvements, and the like made within the spirit and principle of the present invention shall fall within the protection scope of the present invention.

What is claimed is

1. A lock assembly for a towing-type house, comprising:
a housing;
a key lock, which is mounted on an external portion of the housing and has a locking position and an unlocking position;
a deadbolt guide shaft, which is mounted in the housing rotatably, connected to the key lock to rotate with the key lock, and provided with a driven bevel gear;
a poking rod, which is operably connected to the deadbolt guide shaft;
a deadbolt, which is movably mounted in the housing, can move between the locking position and the unlocking position, and is operably connected to the poking rod; and
a motor, which has a locking position and an unlocking position and is engaged with the driven bevel gear through a driving bevel gear on a rotating shaft of the motor to drive the deadbolt guide shaft to rotate.

2. The lock assembly for a towing-type house according to claim 1, wherein the motor is mounted vertically and located above the deadbolt guide shaft.

3. The lock assembly for a towing-type house according to claim 1, wherein one end of the poking rod is connected to the deadbolt guide shaft, and the other end thereof is provided with a boss;
the deadbolt is provided with a guide groove, and the boss is located in the guide groove; and
when the motor or the key lock switches between the locking position and the unlocking position, the deadbolt guide shaft rotates simultaneously and is matched with the guide groove through the boss on the poking rod to drive the deadbolt to switch between the locking position and the unlocking position.

4. The lock assembly for a towing-type house according to claim 1, wherein when the poking rod drives the deadbolt to directly switch between the locking position and the unlocking position, a position of the poking rod is on two sides of a perpendicular bisector of the deadbolt guide shaft respectively.

5. The lock assembly for a towing-type house according to claim 1, further comprising:
an external handle, which is rotatably mounted on the external portion of the housing and can rotate between a retracting position and an extending position; and
a latch bolt, which is connected to the external handle operably and configured as follows: when the external handle is at the retracting position, the latch bolt is at a locking closing position, and a closure apparatus cannot accidentally move from a closing position at this time; and when the external handle is at the extending position, the latch bolt is at an unlocking position, and the closure apparatus can move from the closing position to an opening position at this time.

6. The lock assembly for a towing-type house according to claim 1, further comprising an electronic control panel, which is mounted on the external portion of the housing and operably connected to the motor, wherein a preset digital code is input to drive the motor and simultaneously switch the locking position and the unlocking position of the deadbolt.

7. The lock assembly for a towing-type house according to claim 1, further comprising a first sensor and a second sensor, which are mounted in the housing, wherein
the deadbolt is provided with a triggering portion; and
when the deadbolt switches between the locking position and the unlocking position, the triggering portion triggers the first sensor and the second sensor respectively.

8. The lock assembly for a towing-type house according to claim 7, wherein the first sensor and the second sensor are magnetic sensors, and the triggering portion is a magnet.

9. The lock assembly for a towing-type house according to claim 7, wherein the first sensor and the second sensor are micro motion sensors, and the triggering portion is a convex block.

10. The lock assembly for a towing-type house according to claim 7, further comprising a wireless transmission unit, which is configured to transmit triggering states of the first sensor and the second sensor to an external device.
